(19) United States
(12) Patent Application Publication
(10) Pub. No.: US 2025/0273079 A1
(43) Pub. Date: Aug. 28, 2025

(54) SCORM-compliant PDF Web Reader Enhanced and Extended with custom URL Encoding to enable in-PDF Multi-Media and Interactive Content.

(71) Applicants: Randy Coin, Jackson, WY (US); Thomas R. Peterson, South Lake Tahoe, CA (US); Timothy R. Symons, Cincinnati, OH (US)

(72) Inventors: Randy Coin, Jackson, WY (US); Thomas R. Peterson, South Lake Tahoe, CA (US); Timothy R. Symons, Cincinnati, OH (US)

(21) Appl. No.: 19/046,851

(22) Filed: Feb. 6, 2025

Related U.S. Application Data
(60) Provisional application No. 63/557,579, filed on Feb. 25, 2024.

(51) Int. Cl. G09B 5/02; G06F 16/93; G09B 5/06

(52) U.S. Cl. CPC G09B 5/02; G06F 16/93; G09B 5/065

(57) ABSTRACT

A PDF Web reader enhanced and extended with unique URL encoding makes it possible to use PDF documents as the basis of SCORM-compliant online learning courses and other resources, offering feature sets as comprehensive as those previously achievable only through manual or custom coding of online learning courses, or by using a “rapid eLearning tool” to build one. The invention supports multimedia, including video and audio, and web pages, learning interactions, quizzes, and surveys. It tracks progress, enables content highlighting, notes, and comments, and allows downloading customized documents for personalized learning and future review.

CROSS REFERENCE TO RELATED APPLICATIONS: This application claims priority back to U.S. Provisional No. 63/557,579, filed Feb. 25, 2024, the contents of which are incorporated by reference into this Utility patent application.

STATEMENT REGARDING FEDERALLY SPONSORED RESEARCH OR DEVELOPMENT: This invention was not federally sponsored.

### FIELD OF THE INVENTION

The present invention relates to a PDF Web reader, which is a software application, extended and enhanced with unique Uniform Resource Locator (URL) encoding, to be read by the PDF Web reader, enabling PDF documents as the basis of SCORM-compliant online learning courses and other types of resources (e.g., learning, communications, marketing, sales, etc.) that offer feature sets as comprehensive as those previously achievable only through manual or custom coding of, e.g., online learning courses, or by using a “rapid eLearning tool”. The invention, commonly referred to as “Codex™”, outputs a dynamic, magazine style, highly engaging, multi-media and interactive SCORM-compliant course and/or “learning-adjacent” resource or communication. Because the basis of Codex resources is a PDF, it provides the flexibility to author LMS-trackable content in commonly used tools, like Adobe InDesign and Microsoft Word. In addition to using Codex for SCORM-compliant learning and other resources, Codex can also be integrated with Salesforce® and Google Analytics so that organizations can create and track digital marketing assets related to customer-relationship management activities in the “industry standard” (cloud-based) software.

### BACKGROUND

A Learning Management System (LMS) is a software application to administer, deliver, document, track, and report on educational/training courses. SCORM, which stands for Sharable Content Object Reference Model, is a set of technical standards for online learning software products used to create SCORM-compliant online courses. It is the de facto industry standard today and governs how online learning courses and LMSs communicate with each other. An online learning course must be SCORM compliant for an LMS to be able to administer, deliver, document, track, and report on it, and, as such, being SCORM compliant is extremely important.

SCORM is an evolution of the technical standards, “AICC,” which began in the Aviation Industry in the early 1990s. As the Internet was very young, AICC was first used in a closed system for the same purpose described for SCORM. Prior to SCORM, AICC provided the communication method and data models that allowed online learning courses (commonly referred to as “eLearning”) and LMSs to communicate/work together. “eLearning” (also known as Web-Based Training (WBT)) is defined as a course that learners complete independently on a computer, phone, or tablet, without the presence of a live instructor or peer group.

Organizations started creating online learning courses for employees around the early 2000s. This enabled educating quickly at scale. Since then, professional organizations' employees have generally accessed online learning courses on their organization's dedicated LMSs. Each employee usually has a personal (private) learning profile. Using an LMS is the preferred approach so that organizations can offer the convenience of a central hub for all employee training. Furthermore, they use LMSs to gather, store, and retrieve granular analytics data, e.g., course openings, course completions, progress (of unfinished courses), which screens an employee accessed, which exercises they started/completed, quiz/test results, and more.

The analytics are meaningful to organizations for many reasons, including to gain insight into employees' training interests, their ability to manage training in the midst of completing non-training responsibilities, and to monitor course progress and identify the number or percentage of course completions and quiz scores (if applicable). Furthermore, organizations beholden to training requirements by law or regulation must report specific analytics to external overseers and/or have them at the ready. Therefore, for many organizations, courses that are not and cannot be made to be SCORM compliant in many cases are of no or little use to them.

Prior to approximately 2004, building SCORM-compliant online courses required advanced technical coding skills; in other words, a SCORM-compliant online course could not be built without a programmer (i.e., “coder” or “software engineer”). However, “rapid eLearning tools” were introduced into the market around 2004. These tools provided impactful benefits. They had SCORM-compliance coded-in as an “in-the-box” feature, making it possible to create SCORM-compliant online learning courses “easily” and without technical coding skills; for the first time since the advent of eLearning, a non-technical employee could build a SCORM-compliant course. This made the time to develop a SCORM-compliant course meaningfully faster and easier.

Since 2004, little has changed with rapid eLearning tools, particularly with their user interfaces and feature sets, and the basis from which they are built (i.e., “how” they are built).

The user interface and “learner experience” remains largely universal across online courses created with rapid eLearning tools. For example, visual design: many are comprised of screens that look very much like PowerPoint slides in a deck; navigation: learners click through the screens by interacting with forward and back arrows (or “Next” and “Back” buttons) as if they were advancing slides in a presentation. There is typically a text-based menu (table of contents) that a learner can open and close to jump from topic to topic. Features: The screens can include text, narration, graphics, multi-media, interactive exercises and quizzes, note-taking/free-form text-entry boxes, and custom HTML components. The interface can show a progress bar. The course has bookmarking, meaning when a learner leaves the course, they will return to it in the exact state they left it in (as long as the course is accessed from/hosted on an LMS).

In recent years, rapid eLearning tools have become available that provide a Web user interface. While the visual design and navigation is more like surfing the Web, the features are largely the same.

While also in more recent years, software products became available to package content in a digital book or magazine user interface, most have not been SCORM compliant and therefore not compatible with LMSs. While they offer analytics, e.g., aggregate user data indicating the popularity of specific screens (or “pages”), the data was not aligned with and as robust as the granular data gathered, stored, and captured on LMSs. Therefore, this software was virtually unusable for creating learning programs for organizations hosting their online courses on their LMSs.

The basis of many rapid eLearning tools was initially and still is currently a PowerPoint presentation. When rapid eLearning tools were first introduced, the course author would put content on “screens” almost exactly like they would populate slides in a PowerPoint. The tools evolved so that a course author could begin by importing an existing PowerPoint and use the rapid eLearning tool to add the interactive and multi-media features listed above.

In the rapid eLearning tools that have a Web Interface, the course author must manually build each section; they cannot import an existing PowerPoint or other document.

Historically, PDF documents have not been used as the basis of rapid eLearning, tool-built online courses. The desire for professional organizations, with many policies and procedures, to use their LMS to distribute and track access to these policies and procedures, precipitated the invention of SCORM wrappers. A SCORM wrapper enabled making PDF documents SCORM-compliant. However, it is very important to understand that SCORM wrappers do not communicate granular data to an LMS. They only allow an LMS to track if an employee opened a PDF (not if they've viewed/opened every page).

There are various items in the prior art that describe the LMS such as including US2023144764A1, US2016063873A1, US2014147824A1, U.S. Pat. No. 8,112,446B2 etc. They describe several approaches for an integrated learning and training management system for improved user experiences.

U.S. Ser. No. 10/360,618B1 discloses video data executed by a computer to Sharable Content Object Reference Model (SCORM) package.

U.S. Ser. No. 11/847,579B2 discloses tailoring shareable content object reference model (SCORM)-compliant content to one or more users through a learning management system (LMS) configured to be SCORM-compliant. While these patents and published patent applications are related to learning, they are not the technologies, as is provided by the current invention, that allow a user to actually create a course. Instead, this prior art relates much more to creating and using databases to manage courses—not create a course as is made possible by the current invention.

Fluidbook® transforms PDFs of printed books into HTML5 Flipbooks, including turning documents and content into training assets compatible with LMSs. The business's core focus is catalogs, reports, magazines, and brochures. Regarding learning, Fluidbook® only supports eLearning/WBTs (courses learners complete independently without a live instructor or peer group present, as defined above). Also, Fluidbook® does not offer a “self-serve” model for creating courses, is not integrated with Salesforce®, and does not have a variety of other features Codex™ includes to make for a great user experience.

Flippingbook® is an interactive digital publication with a realistic page-flip effect that makes it look like a printed copy. Created from a PDF, it can be shared as a direct link or embedded into a website. Flippingbook's® focus is marketing and sales content; they are not in the business of learning. Therefore, their product is not SCORM complaint and cannot be tracked on an LMS, thereby rendering it not useful for learning content generally, and certainly not for learning content that organizations need to track on their LMSs. Because Flippingbook® was not developed for learning, its features similarly were not designed for, and do not support, an excellent learning experience.

Storyline 360® is a rapid eLearning authoring tool to create custom interactive and multi-media SCORM-complaint eLearning courses. Storyline 360® provides developers with templates and stock assets to build courses. Storyline 360® was created to develop eLearning/WBTs and is still used only for this purpose. Explicitly, it is not used as a digital Participant Guide. Unlike Codex, Fluidbook®, and Flippingbook, this decades-old industry-specific authoring tool is organized in an entirely different format. Screens look like PowerPoint slides—not magazine pages. One core driver for creating the current invention was offering an alternative to this 20-plus year old “slide presentation” interface a significant population of learners have grown tired of. Unlike Codex, Storyline 360® has not ever included the highly relevant and desired “common sense” features for learners of highlighting text in the course and taking personal notes wherever, whenever, which “students” commonly do when in a class using a hard copy text or notebook and pen/pencil. Used only in learning, Storyline 360® does not integrate with Salesforce®.

Rise® is also a rapid eLearning authoring tool for creating custom interactive and multi-media SCORM-complaint eLearning courses; recently it added an integrated AI assistant. Rise® also does not have a magazine format; course content is organized on screens that look like neither slides nor magazine pages. They look like Web pages. When introduced in 2016, Rise® provided an alternative to the “slide presentation” format of Storyline 360®; however, there were no other significant innovations or features. Rise® is known for supporting a faster development time and responsive design; however, Storyline generally continues to hold a significantly larger market share because it offers more customization and advanced features, making it a better tool for higher-end courses. Storyline® also does not allow for highlighting text in the course and taking personal notes wherever, whenever. Used only in learning, it does not integrate with Salesforce®.

Despite the existing solutions for course content, there remains a need for further improvements within this technology. Specifically, there will likely always be a need for creating SCORM-compliant eLearning courses faster, easier, and more cost effective while being able to maintain and update them as easily and cheaply as possible.

Common-sense features that mimic actions many learners take while learning in a classroom using non-digital materials, e.g., taking notes and highlighting important information, have always been missing.

As organizations today have many employees working at home and distributed globally, there is also a need to also provide a faster, more environmentally friendly, and cost-effective solution for distributing learning. Shipping hard-copy materials around the globe is time consuming, costly, and unfriendly to the environment.

Artificial intelligence is the way of the future. As such, learning will need to incorporate it and there are plans to integrate a closed-system AI chat bot for LMS-hosted courses and to integrate with large language models (e.g., ChatGPT, Copilot, etc.) when hosted elsewhere.

Organizations will always strive for efficiency and therefore want to track all of its learning—in all formats they create learning in (eLearning and instructor-led) —in one place, i.e., the organization's LMS.

The current invention addresses all of these needs by being able to rapidly turn a PDF document into a SCORM-compliant online learning, no matter which aspect of a learning program it is—the entire course, like eLearning and microlearning; a participant guide for a live, facilitated class; etc., —each with the rich feature set and data analytics historically available only by manually coding or using a rapid eLearning tool to build it and future plans to incorporate AI.

Therefore, the present invention provides a PDF Web Reader Enhanced and Extended with Unique URL Encoding that enables adding to the PDF multi-media, interactive content, SCORM compliance, and a variety of other enhancements for the rapid creation of digital learning and other types of digital content and materials to support instructor-led, virtual instructor-led, blended, cascade- and conversation-guide based and microlearning deliveries, (e.g., participant notebooks/workbooks, handouts, etc.). Regardless of how the digital content is being delivered and used (as learning or something else, with or without a live instructor), the content in the form the current invention produces can be very high end, hosted by an organization, accessed by their learners, and tracked online via an LMS. Further, because the current invention is SCORM compliant, like all SCORM compliant assets, it allows the courses/materials to be available offline for review and completion, e.g., while traveling, and—while not a direct feature of the invention, if the LMS includes this feature and the organization has necessary supporting technology—the course can be reuploaded to the LMS after reconnecting to the Internet, synching all work completed.

The invention is useful for the types of learning described above, e.g., eLearning, instructor-led/virtual instructor-led, blended and microlearning. Generally, these are courses organizations make available to or mandate for employees that employees enroll in. Organizations often refer to these as “formal” learning, e.g., product training, sales training, new-hire orientation, leadership development, etc. —any topic an organization provides training on. The current invention is equally useful for “informal” learning.

A type of informal learning is manager “cascades,” which means an organization relies on its managers to educate and/or disseminate communications to their direct reports instead of having all employees enroll in and complete a training course. This is common for change-management initiatives, and in recent years “diversity and inclusion” topics—collectively subjects for which organizations feel “high-touch,” live communications are required. Never before could organizations disseminate SCORM-compliant resources for these types of training. Often, they produced Microsoft-Word-based or PDFs of conversation guides: one for managers that explained how to lead the conversation and one for the direct reports with key points and note-taking space. With the current invention, organizations can track informal learning on their LMS while continuing to produce conversation guides in the familiar “document” format. They can also enhance these documents with multi-media and interactions.

Standard Operating Procedures (SOPs), often documented in a PDF format, are also “informal learning.” Using SCORM wrappers, organizations can make their PDF SOP documents SCORM-compliant. However, all the organization can track on its LMS using a SCORM wrapper is that an individual opened the document. The SCORM-compliance offered by the current invention enables an organization to know granularly how each individual interacted with the document (e.g., which pages did they open), as well as track progress and completion, and can include an interaction for individuals to assert they have, for example, “read and understood” the SOP.

No matter what content or information the current invention is being used to disseminate, it is created with a PDF document. Storyline® and Rise® are authoring tools that an organization would have to pay a fee to license. Furthermore, ®Storyline and Rise® are not word-processing software, like Microsoft Word or—to lesser degree PowerPoint. Writing lengthy documents is much more convenient in word-processing software. Therefore, many organizations creating® Storyline and Rise® courses are also using word-processing software to draft courses. The resultant document looks nothing like the final course. The current invention does not require an authoring tool like® Storyline and Rise®. The course as drafted in Microsoft Word, Adobe InDesign, or any other software that can be saved as a PDF can be transformed into the final course via the invention; no additional “authoring tool” is required.

Finally, the invention is optimum for providing digital marketing solutions, including digital magazines, brochures, and similar with user/customer engagement tracking being tracked in Salesforce®.

While Fluidbook®, Storyline 360®, and Rise® (three of the four prior art programs mentioned) provide standalone eLearning products, none offer a solution for compiling 1) interactive, multi-media, SCORM-compliant participant materials (i.e., participant guides or workbooks) to support instructor-led (in-person or virtual) training; 2) interactive, multi-media, SCORM-compliant conversation guides to support manager cascades; 3) one place to house all components of a microlearning solution; and 4) granularly trackable SOPs. Furthermore, only the current invention and Storyline® offer a trackable training tool with high-end simulations and graphics, as does the current invention, and only Fluidbook® and Flippingbook® provide a digital marketing solution, as does the current invention.

### SUMMARY

The present invention provides an enhanced and extended PDF Web reader that revolutionizes the process of creating SCORM-compliant online courses.

In one aspect the present invention empowers course authors (sometimes called “developers”) (whether authoring courses or marketing or communications content) without technical programming skills to utilize a PDF document as the foundation for creating the SCORM-compliant, interactive, and multi-media output. In essence, the enhanced and extended PDF Web reader enables anyone capable of creating a PDF to develop this output with the same rich features and analytics as courses built with rapid eLearning tools and analytics much richer than PDFs with a SCORM wrapper.

Another aspect of the present invention enhances the engagement of learners in courses built from PDF documents while providing expected analytics. The invention enables the embedding of the multi-media and interactive content customary to modern eLearning courses directly within the course pages, without the need to link to another application. This means the enhanced PDF reader allows the following to be displayed and interacted with directly on the pages: videos and audio files, web pages, and exercises-such as quizzes, drag-and-drop activities, and clickable content that reveals additional information (text, images, or audio). Additionally, it tracks and communicates granular analytics to all LMSs. Historically, achieving this level of functionality required manual coding or the use of rapid eLearning tools. However, the enhanced and extended PDF Web reader enables a course to begin as a PDF document, while providing a learner experience comparable to a course created with a rapid eLearning tool.

Another aspect of the present invention offers efficiency in course development, the time required to build a course using the combination of a PDF and the enhanced and extended PDF Web reader is faster than importing and then enhancing an existing PowerPoint presentation or content from another documents into a rapid eLearning tool to construct a SCORM-compliant course. Thus, this technology offers a streamlined course development process without compromising on time.

Yet a further aspect of the invention is that during the creation of a course, the pdf of the course looks exactly like the live, finished, interactive course. As such, the invention makes it significantly easier for a reviewer to actually see what the final course will look like, as opposed to some of the prior art which the courses are built in a non-final software such as Word, resulting in a “test product” that looks nothing like the final product. This makes it confusing and difficult for reviewers in that they know exactly what their suggested changes will look like in the final product, as opposed to the prior art where reviewers may suggest changes that are almost unrecognizable in the final product.

Moreover, the enhanced and extended PDF Web reader allows the entire course to be printed as well as downloaded and saved locally, retaining learner inputs (e.g., notes and highlights) and completion statuses. This enables learners to take courses anywhere, even without an Internet connection (such as while traveling). These features are not available in courses developed using rapid eLearning tools. Some LMSs offer the functionality to download courses, take them offline, and then re-upload them with all the data generated during offline use. Because the invention is SCORM compliant, courses created using it support this functionality. Therefore, no existing important functionality is compromised.

In addition to these functionalities, the invention features a visually appealing digital-magazine design that emulates the turning of pages in a physical book or magazine, offering a distinct alternative to the conventional PowerPoint-like and web-page interfaces of Storyline 360® and Rise®.

Additionally, the invention incorporates several features not currently available in Storyline® and Rise® courses, including visual navigation with thumbnails, the ability to highlight text, take personal notes outside of designated text-entry boxes, zoom in/out functionality, and search capabilities.

The invention also incorporates a “self-serve” model like the rapid eLearning tools Storyline® and Rise®. Fluidbook® being the only learning-creation tool comparable to the invention does not offer a self-serve model.

The invention also allows third-party Web pages, e.g., cloud-based collaboration tools and surveys via SurveyMonkey, Microsoft Forms, and more, to be displayed on course pages without opening a browser window separately.

The current invention also allows embedding eLearning courses within a course created with the current invention (instead of linking to external resources), displaying entire SCORM-compliant courses directly on the course pages (rather than linking out to them). A learner's work and progress on the courses inside of the course built with the invention is also tracked on LMSs.

The design is responsive, ensuring compatibility with tablets and smartphones. Furthermore, there are plans to integrate social technology, enabling learners in the same organization to engage in discussions within the user interface while using the organization's LMS.

It is compatible with Web Content Accessibility Guidelines (WCAG) and tools like Web Accessibility Initiative—Accessible Rich Internet Applications (WAI-ARIA), making it accessible for learners with disabilities, particularly those who rely on screen readers.

Furthermore, this invention opens the door for workshops and courses, facilitated live with an instructor (whether in-person or virtually online), to be tracked for the first time ever on an organization's LMS. While courses created through this invention can be “self-paced” and “asynchronous” (industry terms meaning “without an instructor”), the digital magazine format naturally lends itself to creating and/or packaging learner materials (e.g., “Participant Workbooks,” “Participant Guides,” and handouts), which are typically provided in workshops. By hosting participant materials on their LMS, organizations can now track course completion and learner activity within these materials. Existing digital course technology has not been used in this way previously.

There are plans to incorporate a closed-system chat bot that would access content packaged within the course to answer learners' questions.

Additionally, the invention provides features that are not “learner facing” but allow for an easier creation and maintenance process. One is a bug tracker that allows reviewers to efficiently log copy errors, technical issues, and requests for changes prior to finalizing the course and publishing it to an LMS for learners to take. Logged bugs will appear at the specific location in the course the reviewer logged it. Each comment will allow any number of replies from other reviewers, and replies will contain a date/time stamp and the name of the user who entered it.

Another is unique page identifiers that will remain with the page they are originally assigned to. The benefit of this feature is that as pages are added or removed throughout the evolution of a course's development, the programming will remain intact as the course expands or contracts in page count. Allowing for user highlights, comments, and bug reports to remain with a specific page even if the pages are reordered, deleted, or significantly edited.

As it is clear that the invention can also be used to package Marketing and Sales content digitally and enhance it with the feature set, there are plans to integrate it with Salesforce and Google Analytics (in addition to LMSs) so that organizations can track user/customer engagement. Additionally, there are plans to develop a “front end” that would allow any individual to create a SCORM-compliant, multi-media, interactive course from a PDF using the invention.

In summary, the enhanced and extended PDF Web reader not only prioritizes function but also offers a visually appealing, analytics- and feature-rich environment that learners can personalize for high utility for organizations and high learner engagement, making it a versatile and innovative tool in the realm of online education.

### BRIEF DESCRIPTION OF THE DRAWINGS

As a basic summary of the invention, the enhanced and extended PDF Web reader provides a means of using a PDF document for the purpose of compiling and distributing SCORM-compliant, feature- and analytics-rich, accessible online learning courses to employees or members of an organization in organizations that need accessible content and to protect and track content access and analytics (to varying degrees). However, as mentioned above, while organizations are using SCORM wrappers to make PDF documents SCORM-compliant, they do not produce the feature- and analytics-rich courses that manually coded and/or rapid eLearning-tool based courses do, and these latter courses do not use PDFs as their starting point i.e., import a PDF to begin building the course. This makes it possible to turn any existing PDF quickly and easily at a minimum into a SCORM-compliant course with rich data analytics.

The proposed enhanced and extended PDF Web reader enables the PDFs used as the basis of SCORM-compliant online courses to have the following unique features.

The illustrated embodiments of the subject matter will be best understood by reference to the drawings, wherein like parts are designated by like numerals throughout. The following description is intended only by way of example, and simply illustrates certain selected embodiments of devices, systems, and methods that are consistent with the subject matter as claimed herein, wherein:

FIG. 1A depicts the user interface and visual navigation through a PDF-document based course in the enhanced and extended PDF Web reader, in accordance with an embodiment of the present disclosure.

FIG. 1B depicts default text-based navigation for online courses that resemble a PowerPoint presentation built with a traditional rapid e-Learning tool.

FIG. 1C depicts another navigation method in an online course that resembles a Web page built with a traditional rapid e-Learning tool.

FIG. 2 depicts a course built with a PDF document and opened in the enhanced and extended PDF Web reader in which “the learner” digitally annotated (highlighted) text in the course, in accordance with an embodiment of the present disclosure.

FIG. 3 depicts a PDF-based course opened in the enhanced and extended PDF Web reader with the functions accessible in the lower part of the user interface showing the functionality to download and save a copy of the course directly from the Learning Management System (LMS) onto their personal devices, in accordance with an embodiment of the present disclosure.

FIG. 4A depicts a PDF-based course opened in the enhanced and extended PDF Web reader offers delivery of multi-media content right on the page within the course, in accordance with an embodiment of the present disclosure.

FIG. 4B depicts multi-media content integrated into a PDF document and opened in a desktop PDF reader. It is not possible to play the media on the page. Only links can be included, which the user clicks to open the media in another window.

FIGS. 5A-5D depict a PDF-based course opened in the enhanced and extended PDF Web reader that includes interactive elements in the course content.

FIGS. 6A and 6B illustrates an exemplary process flow diagram for converting a PDF document into a SCORM-compliant online course with rich interactive, multi-media features and analytics using the enhanced and extended PDF Web reader of the present invention.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The detailed description of various exemplary embodiments of the disclosure is described herein with reference to the accompanying drawings. It should be noted that the embodiments are described herein in such details as to clearly communicate the disclosure. However, the number of details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may, in fact, be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the term “learner” refers to person/people taking a course. For example, the learner is a “user,” “student,” or employee taking a course. The words are interchangeable.

The invention provides a PDF Web reader extended and enhanced with unique URL (Uniform Resource Locator) encoding to make it possible to use PDF documents as the basis of SCORM-compliant online learning courses.

The enhanced and extended PDF Web reader provides a means of using a PDF document for the purpose of compiling and distributing SCORM-compliant, feature- and analytics-rich, accessible online learning courses to employees or members of an organization in organizations that need accessible learning content and to protect and track that content access and its analytics (to varying degrees). However, as mentioned above, while organizations are using SCORM wrappers to make PDF documents SCORM-compliant, they do not produce the feature- and analytics-rich courses that manually coded and/or rapid eLearning-tool based courses do, and these latter courses do not use PDFs as their starting point i.e., start with a PDF to begin building the course. The enhanced and extended PDF Web reader makes it possible to turn any existing PDF quickly and easily—at a minimum—into a SCORM-compliant course that with rich data analytics.

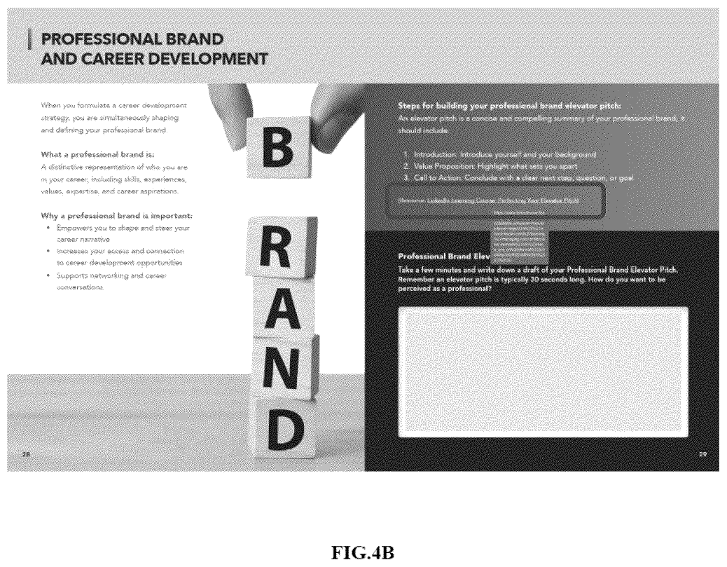

The enhanced and extended PDF Web reader converts what would otherwise be present only as links and buttons in PDF documents (as shown in FIG. 4B), into multi-media and interactive content; allows Web pages to be embedded for learners to interact with; and enables PDF documents to be SCORM compliant and therefore communicate rich analytics to LMSs.

The proposed extended and enhanced PDF Web reader enables the PDFs used as the basis of SCORM-compliant online courses to have the following unique features:

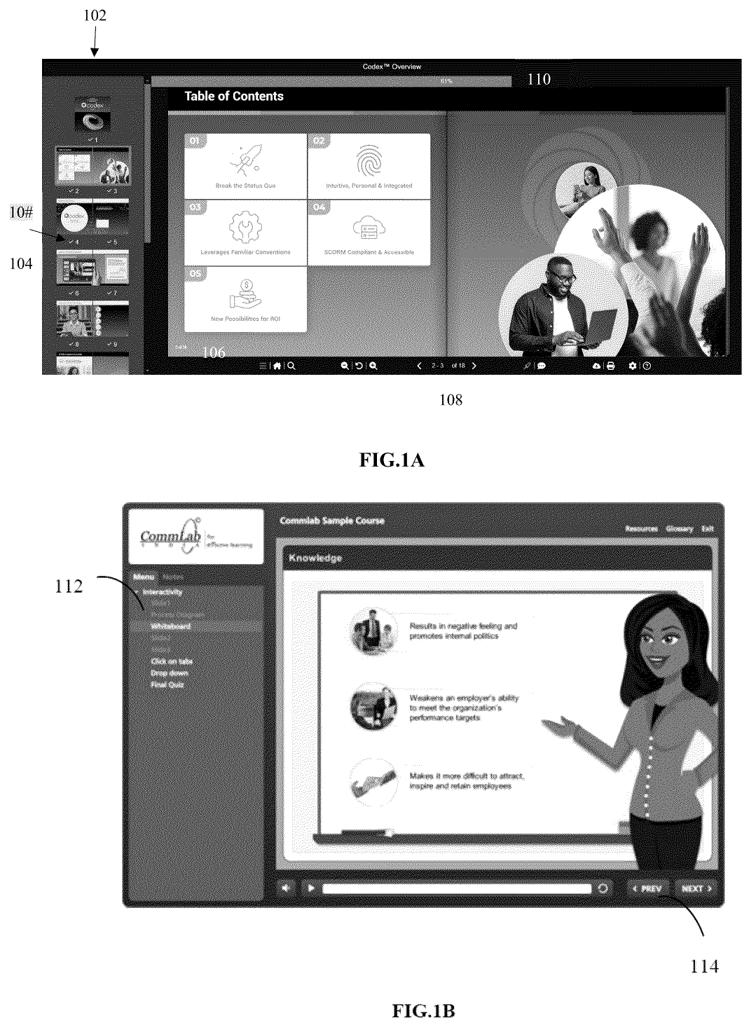

(i) Visual Navigation: As shown in FIG. 1A, the PDF-based course provides Visual Navigation. Learners can navigate the course multiple ways. The PDF reader also provides touchscreen capabilities. Learners can navigate the course either with click or touch. Learners can click/touch the page thumbnails 104 in the thumbnail menu 102 to jump from page to page. Furthermore, learners can also click/touch the corners 106 of pages to turn one page forward or backward. Forward and back arrows 108 below the pages are also available for navigating one page at a time. FIG. 1B shows a default navigation in traditional rapid e-Learning tool authored courses is a text-based menu 112 and forward and back arrows (“Next” and “Prev”/“Back”) 114. FIG. 1C shows a course produced in a more recent rapid eLearning tool that creates courses with “Web page” interfaces, which also include a text-based menu 112. Learners scroll the main screen up and down just like scrolling a Web page. Text-based navigation typically only allows navigating to the first screen of a topic or the top of a page in a course with a Web-based interface. This means a learner does not know which screen they are on in a topic easily and could become disoriented with where they are in the course.

Hence, as shown in FIG. 1A the visual thumbnail-based navigation provides learners the ability to orient to their place in the course easily like orienting to the page they are on in a physical book. A checkmark corresponding to a page appears on that thumbnail when a learner visits that page. Further, learners can also pinpoint a specific page. Locating specific screens within sections when a section has more than one screen is not available via text-only menus. The visual menu's location is flexible. It can display left, right, top or bottom of the interface.

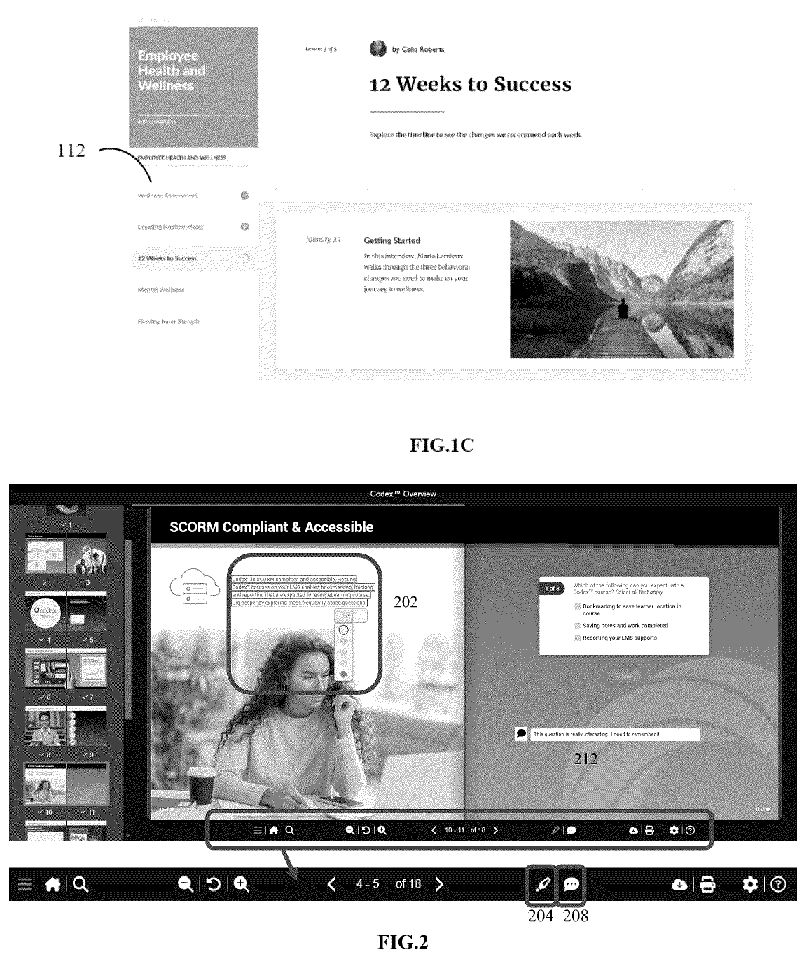

(ii) Annotation: As illustrated in FIG. 2, the PDF-based course grants learners the capability to digitally annotate the course content. These features 204, 208 allows users to 212 create text notes and 202 highlight texts on pages, similar to annotation functionalities available in editable digital files. These annotation features 204 and 208 empower users to personalize their learning experience by adding their insights and highlighting key points directly in the course. Used in concert with the enhanced and extended PDF Web reader, learners' unique inputs are saved to the LMS from which they are accessing the course. They are also preserved when learners download the course.

Conversely, courses developed with rapid eLearning tools currently lack built-in annotation functionalities. The inclusion of digital annotation capabilities within the extended and enhanced PDF Web reader improves learner engagement and interactivity, enabling learners to interact in new ways with digital course content and make personalized enhancements to their learning materials.

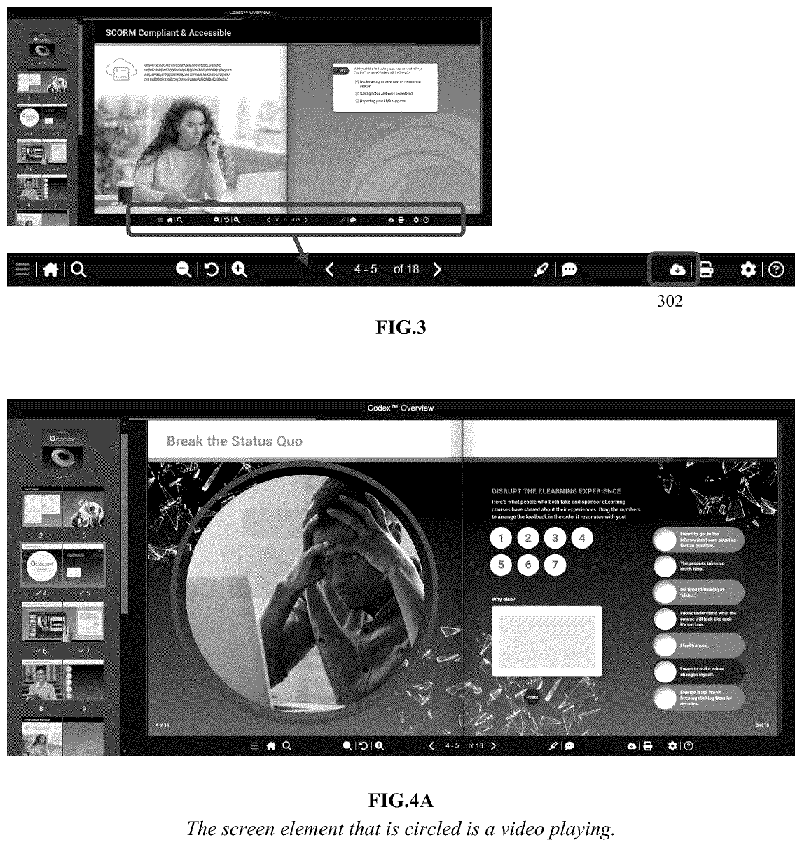

(iii) Downloadable: As depicted in FIG. 3, the enhanced and extended PDF Web reader offers learners the functionality to print and/or download and save 302 a copy of the course onto their personal devices. This downloadable version includes all notes and annotations inputted during the course's use on the LMS. Additionally, the downloaded version can maintain links to all interactive exercises and multi-media elements, providing a comprehensive learning experience even when viewing the content outside of the LMS.

In contrast, courses created with rapid eLearning tools currently lack the capability to be downloaded. This capability, enabled by the enhanced and extended PDF Web reader, provides flexibility for learners, allowing them to access course materials offline.

(iv). Multi-Media Content: As illustrated in FIG. 4A, the enhanced and extended PDF Web reader offers course designers the capability to seamlessly embed audio and video files directly into the course pages, facilitating the delivery of multi-media content within the course. This feature ensures that videos play, and external Web pages display directly on the page itself, eliminating the need for learners to navigate to external websites to access multi-media and other content.

Conversely, traditional PDFs lack the functionality to embed multi-media and external Web page content directly, instead only allowing for the inclusion of links to external multi-media resources. In such cases, when learners click on these links, they are redirected outside the course interface to external sites where the multi-media and website content is hosted.

FIG. 4B, while multi-media content is commonly integrated into courses developed using rapid eLearning tools, the absence of the enhanced and extended PDF Web reader limits traditional PDFs to including only links to multi-media content. The ability to embed multi-media directly within the course pages significantly enhances the learning experience by keeping learners engaged within the course interface without the need for external navigation.

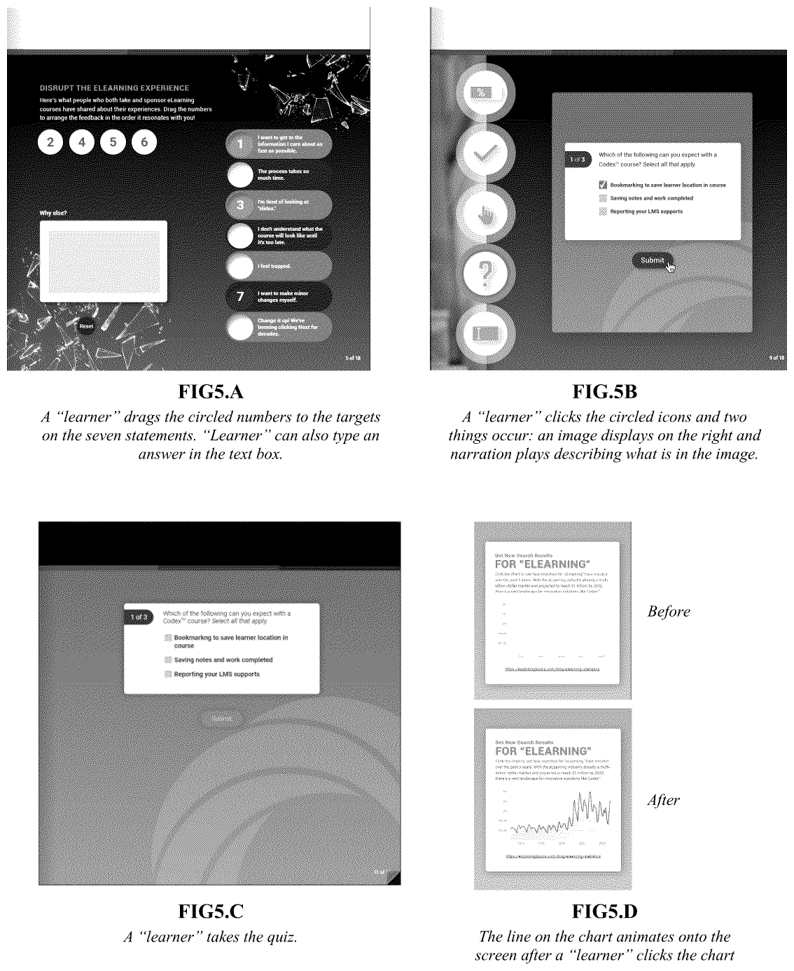

(iv) Interactive Content: As depicted in FIGS. 5A-C, the PDF Web reader enables interactive elements in the course. These interactive components empower learners to actively engage with the material. For instance, they can click on icons, text, or images to reveal previously concealed information, access webpages by clicking on uniform resource locator (URL) addresses and participate in sorting or matching exercises by dragging and dropping objects on the page. Moreover, quiz questions, including single and multiple-answer multiple choices, true/false, fill in the blank, short essay, etc., can be seamlessly integrated into the course pages, enriching the learning experience with interactive assessments.

While the inclusion of interactive content is standard in courses developed using rapid eLearning tools, traditional PDFs lack the capability to provide these features without the enhanced and extended PDF Web reader. Consequently, these interactive elements significantly enhance the learning experience for learners, fostering greater engagement and comprehension.

(v) Bookmarking/Saved Inputs: These features guarantee that learners can easily see what parts of the course they've completed and seamlessly resume their progress within the course from where they left off. Upon returning, learners will be directed back to the exact page they were on when they exited the course, and all completed work within the course will remain intact. Although bookmarking is a common feature in courses developed using rapid eLearning tools, traditional PDFs using SCORM wrappers lack the capability to offer bookmarking at the page level without the enhanced and extended PDF Web reader.

(vi) Percent Complete: As seen in FIG. 1A, this feature indicates to learners how much of the course they have completed via a visual bar and a number (percentage).

(vii) Reset: This feature enables users to override saved bookmarks and inputs, effectively resetting the course as if they had never started it. This allows the invention to provide the same features as courses built in rapid eLearning tools (the industry de facto standard) to demonstrate that a consumer is not compromising by using the invention described in this patent application, but rather, this invention provides everything that rapid eLearning tools offer with the aforementioned benefits described in this patent application.

(viii) Language Capability: This feature enables users to produce contents in multiple languages.

(ix) Development Speed and Ease of Maintenance: When building a course using a traditional rapid eLearning tool, the individuals possessing the subject matter expertise necessary for generating course content often lack the technical proficiency required to develop the course within the software like a rapid eLearning tool. Moreover, they may not have access to the necessary licenses for the tool. Additionally, performing extensive text editing within such a tool can be challenging. Consequently, initial drafts of courses are frequently authored using word-processing applications like Microsoft Word, Google Docs, PowerPoint, or similar software. By removing the need for another development tool beyond the Word processing tool that can be saved as a PDF, this approach facilitates ease of editing and revisions for collaborators responsible for developing course content.

This rapid eLearning course development process entails eventual migration of the content from the document the course was originally authored in into the rapid eLearning tool. Even if a PowerPoint presentation is imported, significant alterations occur during the process. Visual design is typically enhanced, exercises and multi-media elements described only in text/with words are transformed into interactive course components, and recorded audio and video are integrated, deviating from their original text-based script format. Once the content is transferred into the rapid eLearning tool, individuals who contributed to the course's creation usually lack the technical skills to make further modifications independently.

Contrarily, the enhanced and extended PDF Web reader allows the PDF document to serve as the foundation of the course without necessitating migration to another software platform like a rapid eLearning tool. Consequently, any individual capable of editing a PDF can update the course text, as no specialized technical skills or knowledge of rapid eLearning tools are required. This stands in contrast to courses developed using rapid eLearning tools, where updates typically demand proficiency in the specific software utilized.

Utilizing the enhanced and extended PDF Web reader streamlines the process of updating course content. “SCORMING” the PDF through the enhanced and extended PDF Web reader takes mere minutes, whether it's the initial run-through or subsequent updates. This efficiency surpasses the time required for making updates to course content housed within a rapid eLearning tool.

Using an enhanced and extended PDF Web reader in conjunction with a PDF file can indeed provide added functionality and interactivity to the learning experience. While the invention is the enhanced and extended PDF Web reader, this invention would not be possible without PDF documents. That said, this invention allows for stretching the limits of what PDF documents have been used for and do. In other words, because of this invention, features (like those in traditional eLearning courses) can be programmed into PDF documents that only work because of this invention. By leveraging these features, e.g., external multi-media and We b elements, such as videos, audio files, and interactive exercises, the PDF-document-based course content can be as engaging and effective as an eLearning course, if not more.

When the output is hosted on an LMS as a SCORM-compliant online course, the PDF can display any external media and Web elements without the learner being aware that the media and Web pages “live” somewhere outside of the course. This provides an integrated experience for the learner and greater flexibility in delivering multi-media-rich content without the limitations of traditional PDF files.

For example, the PDF might contain embedded objects that reference media and content external to the course hosted on, e.g., websites or Intranet sites. Yet these external elements can be dynamically loaded into the PDF viewer within the web browser, providing a unified learning experience for the learner, i.e., they can access everything in the course right within the pages of the course.

This approach provides flexibility for content creators to update or change media elements without having to modify the PDF itself, simplifying the content maintenance process. Overall, it enhances the ease of updating content no matter where it is being hosted.

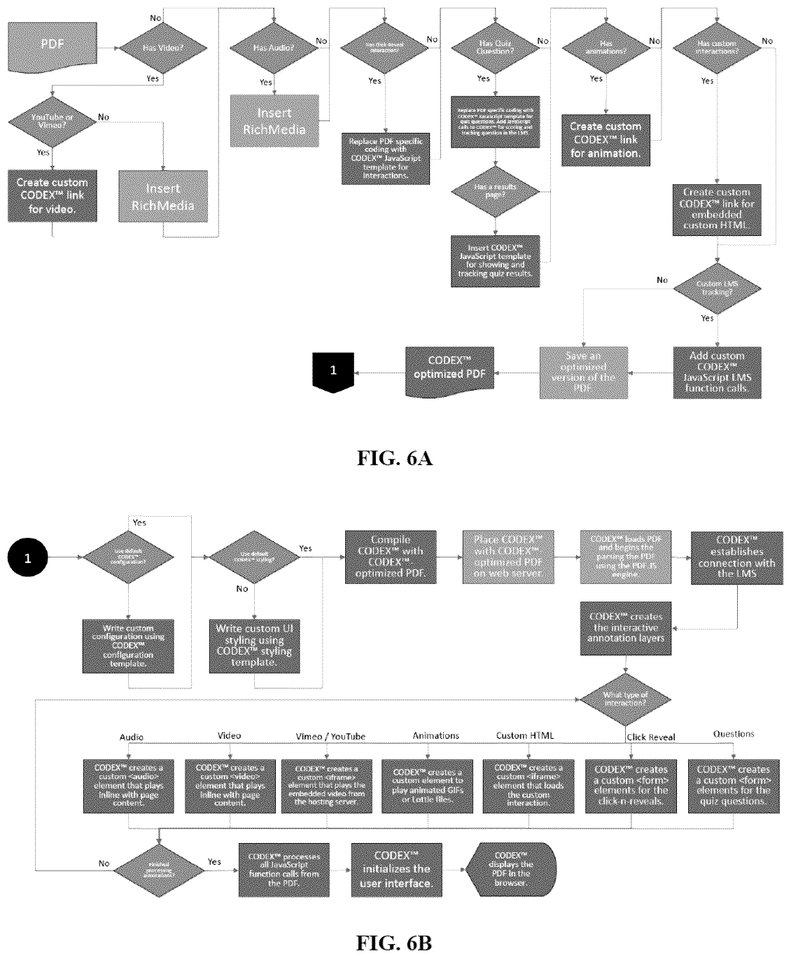

FIGS. 6A-6B illustrate an exemplary process flow diagram for converting a PDF document into a SCORM-compliant online course with rich interactive and multi-media features and analytics using the enhanced and extended PDF Web reader.

Further, the terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art.

What is claimed is:

1. A suite of digital tools to enable digital content authoring comprising:
an enhanced and extended PDF Web reader and proprietary code, configured to enable,
converting conventional links and buttons within PDF documents into dynamic multi-media and interactive elements; facilitating the embedding of Web pages within the PDF for user interaction; and enabling PDF documents to adhere to SCORM standards, facilitating the exchange of comprehensive analytics with learning management systems (LMSs),
wherein the suite enables Learners to:
(i) Experience the course content in a digital-magazine format,
(ii) Navigate the course multiple ways, including through visual navigation such as clicking page thumbnails in a thumbnail menu to jump from page to page,
(iii) Digitally annotate the course content (highlight text and take notes),
(iv) Download and print and save a copy of the course onto their personal devices preserving all of their inputs,
(v) Access audio and video files, and content hosted on external Websites, directly on course pages, facilitating the delivery of these types of content within the course rather than external to it,
(vi) Interact with elements in the course content,
(vii) Bookmark and save all inputs and completed work, and seamlessly resume their progress within the course from where they left off,
(viii) Reset the course as if they had never started it,
(ix) Search the content for words and phrases of interest,
(x) Be accommodated for should they need accessible content,
Wherein the suite enables course developers to:
(i) Develop their own courses with the invention using the planned self-serve model,
(ii) Embed SCORM-compliant courses within courses created using the invention or another authoring tool,
(iii) Use the bug tracker to manage reviewer feedback and resultant changes in an orderly way,
(iv) Create SCORM-compliant, responsive learning content, trackable on LMSs, and,
(v) Create sales and marketing content trackable in Salesforce®.

2. A suite of digital tools comprising:
an enhanced and extended PDF Web reader, configured to enable a number of functions, wherein the functions include,
converting conventional links and buttons within PDF documents into dynamic multi-media and interactive elements;
allowing the embedding of web pages within the PDF for user interaction; and
enabling PDF documents to adhere to SCORM standards, facilitating the exchange of comprehensive analytics with SCORM-compliant learning management systems (LMSs).

3. The suite of digital tools of claim 2, additionally comprising:
the ability to be integrated with any database, beyond LMSs and Salesforce®.

4. The suite of digital tools of claim 2, additionally comprising:
Enabling integration with AI.

5. The suite of digital tools of claim 2, additionally comprising:
a complete front end, allowing anyone to build a course in the current invention by learning how to use the front end software.

6. The suite of digital tools of claim 2, additionally comprising: wherein the PDF Web reader comprises A digital-magazine format.

7. The suite of digital tools of claim 6, additionally comprising: wherein the PDF Web reader comprises providing interactive elements in the course content.

8. The suite of digital tools of claim 7, wherein the PDF Web reader comprises enabling users and learners to digitally annotate the course content, wherein users and learners can print and download and save a copy of the course onto their personal devices.

9. The suite of digital tools of claim 8, wherein course authors and developers are able to seamlessly embed third-party Web pages (as permitted by third parties), audio, and video files directly into course pages, facilitating the delivery of multi-media content within the course.

10. The suite of digital tools of claim 9, wherein users and learners can bookmark and save inputs, wherein users and learners can seamlessly see what they have completed and resume their progress within the course from wherein they left off.

11. The suite of digital tools of claim 10, wherein users and learners can override save bookmarks, and further reset the course as if they had never started it.

12. The suite of digital tools of claim 2, additionally comprising: wherein the PDF Web reader comprises at least one of:
(i) A digital-magazine format,
(ii) visual navigation to a course, wherein users/learners can navigate the course multiple ways, such as clicking page thumbnails in a thumbnail menu to jump from page to page,
(iii) enabling users and learners to digitally annotate the course content,
(iv) enabling users and learners to print and download and save a copy of the course onto their personal devices,
(v) enabling course authors and developers to seamlessly embed third-party Web pages (as permitted by third parties), audio, and video files directly into course pages, facilitating the delivery of multi-media content within the course,
(vi) providing interactive elements in the course content,
(vii) enabling users and learners to bookmark and save inputs, wherein users and learners can seamlessly see what they have completed and resume their progress within the course from wherein they left off, and,
(viii) enabling users and learners to override save bookmarks, and further reset the course as if they had never started it.

13. The suite of digital tools of claim 12, additionally comprising: wherein the PDF Web reader comprises a visual navigation to a course, wherein users/learners can navigate the course multiple ways, such as clicking page thumbnails in a thumbnail menu to jump from page to page.

14. The suite of digital tools of claim 13, additionally comprising an ability to enable users and learners to digitally annotate the course content.

15. The suite of digital tools of claim 14, additionally comprising an ability to enable users and learners to download and save a copy of the course onto their personal devices.

16. The suite of digital tools of claim 15, additionally comprising an ability to enable users and learners to seamlessly embed audio and video files directly into PDF pages.

17. The suite of digital tools of claim 16, additionally comprising an ability to facilitate the delivery of multi-media content within the course,
(i) providing interactive elements into the course content,
(ii) enabling users and learners to bookmark and save Inputs, wherein users and learners can seamlessly resume their progress within the course from where they left off,
(iii) enabling users and learners to override bookmarks, and further reset the course as if they had never started it.

18. The suite of digital content authoring tools of claim 17, additionally comprising an ability to facilitate the delivery of the following programs on an LMS: standalone eLearning courses, blended format learning programs, interactive participant materials for instructor-led/virtual instructor-led trainings, microlearning, conversation-based manager cascades, trackable standard operating procedures, and trackable new hire orientation programs.

19. A suite of digital tools consisting of:
an enhanced and extended PDF Web reader, configured to enable a number of functions, wherein the functions include,
converting conventional links and buttons within PDF documents into dynamic multi-media and interactive elements;
allowing the embedding of web pages within the PDF for user interaction; and
enabling PDF documents to adhere to SCORM standards, facilitating the exchange of comprehensive analytics with SCORM-compliant learning management systems (LMSs),
wherein the digital content authoring tool can be integrated with any database, and AI, additionally comprising a complete front end, allowing anyone to build a course in the current invention by learning how to use the front end software.

20. The suite of digital tools of claim 19, wherein the PDF Web reader comprises:
(i) A digital-magazine format,
(ii) visual navigation to a course, wherein users/learners can navigate the course multiple ways, such as clicking page thumbnails in a thumbnail menu to jump from page to page,
(iii) enabling users and learners to digitally annotate the course content,
(iv) enabling users and learners to print and download and save a copy of the course onto their personal devices,
(v) enabling course authors and developers to seamlessly embed third-party Web pages (as permitted by third parties), audio, and video files directly into course pages, facilitating the delivery of multi-media content within the course,
(vi) providing interactive elements in the course content,
(vii) enabling users and learners to bookmark and save inputs, wherein users and learners can seamlessly see what they have completed and resume their progress within the course from where they left off,
(viii) enabling users and learners to override save bookmarks, and further reset the course as if they had never started it.
